(19) United States
(12) Patent Application Publication
(10) Pub. No.: US 2019/0033494 A1
(43) Pub. Date: Jan. 31, 2019

(54) PROTECTIVE FILM AND ELECTRONIC DEVICE HAVING THE SAME ATTACHED THERETO

(71) Applicant: Samsung Electronics Co., Ltd., Gyeonggi-do (KR)

(72) Inventors: Young Gyun KIM, Gyeonggi-do (KR); Min Jung KIM, Gyeonggi-do (KR); Soon Cheol KWON, Seoul (KR)

(21) Appl. No.: 16/039,513

(22) Filed: Jul. 19, 2018

(30) Foreign Application Priority Data
Jul. 28, 2017 (KR) 10-2017-0096454

(51) Int. Cl. G02B 1/14; B32B 7/12; B32B 27/08; G06F 1/16

(52) U.S. Cl. CPC G02B 1/14; B32B 7/12; B32B 27/08; G06F 1/1637; B32B 2457/20; B32B 2255/10; B32B 2255/26; G06F 1/1656

(57) ABSTRACT

An electronic device is disclosed including a side member at least partially enclosing a hollow formed between a first surface and a second surface, the second surface disposed facing away from the first surface, a display panel disposed between the first and second surfaces, arranged to display content towards the first surface, a cover panel disposed on the display panel, and a protective film mounted on the cover panel, including: a base layer disposed on the cover panel, a hard coating layer coated on the base layer, and an anti-fingerprint (AF) coating layer coated on the hard coating layer, including a thickness between 80 nm and 200 nm.

### CROSS-REFERENCE TO RELATED APPLICATION(S)

This application is based on and claims priority under 35 U.S.C. § 119 to Korean Patent Application No. 10-2017-0096454, filed on Jul. 28, 2017, in the Korean Intellectual Property Office, the disclosure of which is incorporated by reference herein its entirety.

### BACKGROUND

### 1. Field

Various embodiments of the present disclosure relate to a protective film and an electronic device having the same attached thereto.

### 2. Description of Related Art

Mobile electronic devices, such as smartphones, tablet PCs, wearable devices, and the like, are now widely used. These electronic devices may display various contents (e.g., text, images, or videos) through a display (or a display panel). The display may be protected by a glass cover exposed to an exterior of the device. The glass cover is often scratched or dented due to an external impact, as the electronic devices are used. Accordingly, the glass cover may be protected by a protective film (e.g., a film or a sheet) attached to the surface of the glass cover. The protective film may have anti-fingerprint (AF) characteristics which prevent a user's fingerprint mark from staining the glass cover, as well as the utility of better absorbing external impacts.

The above information is presented as background information only to assist with an understanding of the present disclosure. No determination has been made, and no assertion is made, as to whether any of the above might be applicable as prior art with regard to the present disclosure.

### SUMMARY

A protective film attached to an electronic device in the related art may implement anti-fingerprint characteristics by adding a chemical solution having anti-fingerprint characteristics to a hard coating solution. In this case, a fluorine component contained in the hard coating solution may be expressed on the surface, and anti-fingerprint characteristics may be deteriorated due to an increase in the distance between fluorine polymers.

Another protective film attached to an electronic device in the related art may include an AF coating layer formed on a hard-coated protective film by using a dry process using depositing or sputtering or by using a wet spray process using a wet nano-coater. In this case, there are problems in that an AF coating solution is expensive and protective films obtained through a blanking process have to be separately processed. Furthermore, there is difficulty in applying the processes to a film or a sheet manufactured in a roller type, which results in an increase in manufacturing cost.

According to various embodiments of the present disclosure, an AF coating layer may be formed on hard-coated fabric by using a micro gravure apparatus. Accordingly, manufacturing cost of a protective film may be reduced.

In accordance with an aspect of the present disclosure, an electronic device is disclosed including a side member at least partially enclosing a hollow formed between a first surface and a second surface, the second surface disposed facing away from the first surface, a display panel disposed between the first and second surfaces, arranged to display content towards the first surface, a cover panel disposed on the display panel; and a protective film mounted on the cover panel, including a base layer disposed on the cover panel, a hard coating layer coated on the base layer, and an anti-fingerprint (AF) coating layer coated on the hard coating layer, wherein the AF coating layer has a thickness between 80 nm and 200 nm.

In accordance with an aspect of the present disclosure, a protective film attachable to an electronic device is disclosed, including a base layer disposed on a cover panel of the electronic device, a hard coating layer coated on the base layer, and an anti-fingerprint (AF) coating layer coated on the hard coating layer, wherein the AF coating layer has a thickness between 80 nm and 200 nm.

In accordance with an aspect of the present disclosure, an electronic device is disclosed, a side member at least partially enclosing a hollow formed between a first surface and a second surface of the electronic device, the second surface disposed facing away from the first surface, a display panel and disposed between the first and second surfaces, arranged to display content towards the first surface, a back cover attached to the second surface, and a protective film disposed on the back cover, including: a base layer disposed on the back cover, a hard coating layer coated on the base layer, and an anti-fingerprint (AF) coating layer coated on the hard coating layer, wherein the AF coating layer has a thickness between 80 nm and 200 nm.

According to various embodiments of the present disclosure, a protective film and an electronic device having the same attached thereto may include an anti-fingerprint coating layer formed through a micro gravure process, thereby reducing manufacturing cost. The micro gravure process may form the anti-fingerprint coating layer by using fabric in a roller form.

According to various embodiments of the present disclosure, a protective film and an electronic device having the same attached thereto may include a high-performance anti-fingerprint coating layer with a thickness between 80 nm and 200 nm that is formed through a micro gravure process.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an electronic device having a protective film attached thereto according to various embodiments;

FIG. 2 illustrates a configuration of the protective film according to various embodiments;

FIG. 3 illustrates a micro gravure apparatus for AF coating according to various embodiments;

FIG. 4 illustrates an intaglio structure of a gravure roller according to various embodiments;

FIG. 5 is a flowchart illustrating a micro gravure process according to various embodiments;

FIG. 6 illustrates a chemical bond of an AF coating layer according to various embodiments;

FIG. 7 illustrates a bond of an AF coating solution including a low-refractivity fluorine chain according to various embodiments; and

FIG. 8 illustrates a block diagram of an electronic device in a network environment according to various embodiments.

### DETAILED DESCRIPTION

Hereinafter, various embodiments of the present disclosure will be described with reference to the accompanying drawings. Accordingly, those of ordinary skill in the art will recognize that modification, equivalent, and/or alternative on the various embodiments described herein can be variously made without departing from the present disclosure. With regard to description of drawings, similar components may be marked by similar reference numerals.

In the disclosure disclosed herein, the expressions “have”, “may have”, “include” and “comprise”, or “may include” and “may comprise” used herein indicate existence of corresponding features (for example, elements such as numeric values, functions, operations, or components) but do not exclude presence of additional features.

In the disclosure disclosed herein, the expressions “A or B”, “at least one of A or/and B”, or “one or more of A or/and B”, and the like used herein may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like used herein may refer to various elements of various embodiments of the present disclosure, but do not limit the elements. For example, such terms are used only to distinguish an element from another element and do not limit the order and/or priority of the elements. For example, a first user device and a second user device may represent different user devices irrespective of sequence or importance. For example, without departing the scope of the present disclosure, a first element may be referred to as a second element, and similarly, a second element may be referred to as a first element.

It will be understood that when an element (for example, a first element) is referred to as being “(operatively or communicatively) coupled with/to” or “connected to” another element (for example, a second element), it can be directly coupled with/to or connected to the other element or an intervening element (for example, a third element) may be present. In contrast, when an element (for example, a first element) is referred to as being “directly coupled with/to” or “directly connected to” another element (for example, a second element), it should be understood that there are no intervening element (for example, a third element).

According to the situation, the expression “configured to” used herein may be used as, for example, the expression “suitable for”, “having the capacity to”, “designed to”, “adapted to”, “made to”, or “capable of”. The term “configured to (or set to)” must not mean only “specifically designed to” in hardware. Instead, the expression “a device configured to” may mean that the device is “capable of” operating together with another device or other components. CPU, for example, a “processor configured to (or set to) perform A, B, and C” may mean a dedicated processor (for example, an embedded processor) for performing a corresponding operation or a generic-purpose processor (for example, a central processing unit (CPU) or an application processor) which may perform corresponding operations by executing one or more software programs which are stored in a memory device.

Terms used in this specification are used to describe specified embodiments of the present disclosure and are not intended to limit the scope of the present disclosure. The terms of a singular form may include plural forms unless otherwise specified. Unless otherwise defined herein, all the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal detect unless expressly so defined herein in various embodiments of the present disclosure. In some cases, even if terms are terms which are defined in the specification, they may not be interpreted to exclude embodiments of the present disclosure.

An electronic device according to various embodiments of the present disclosure may include at least one of smartphones, tablet personal computers (PCs), mobile phones, video telephones, electronic book readers, desktop PCs, laptop PCs, netbook computers, workstations, servers, personal digital assistants (PDAs), portable multimedia players (PMPs), MP3 players, mobile medical devices, cameras, and wearable devices. According to various embodiments of the present disclosure, the wearable devices may include accessories (for example, watches, rings, bracelets, ankle bracelets, glasses, contact lenses, or head-mounted devices (HMDs)), cloth-integrated types (for example, electronic clothes), body-attached types (for example, skin pads or tattoos), or implantable types (for example, implantable circuits).

Hereinafter, electronic devices according to an embodiment of the present disclosure will be described with reference to the accompanying drawings. The term “user” used herein may refer to a person who uses an electronic device or may refer to a device (for example, an artificial electronic device) that uses an electronic device.

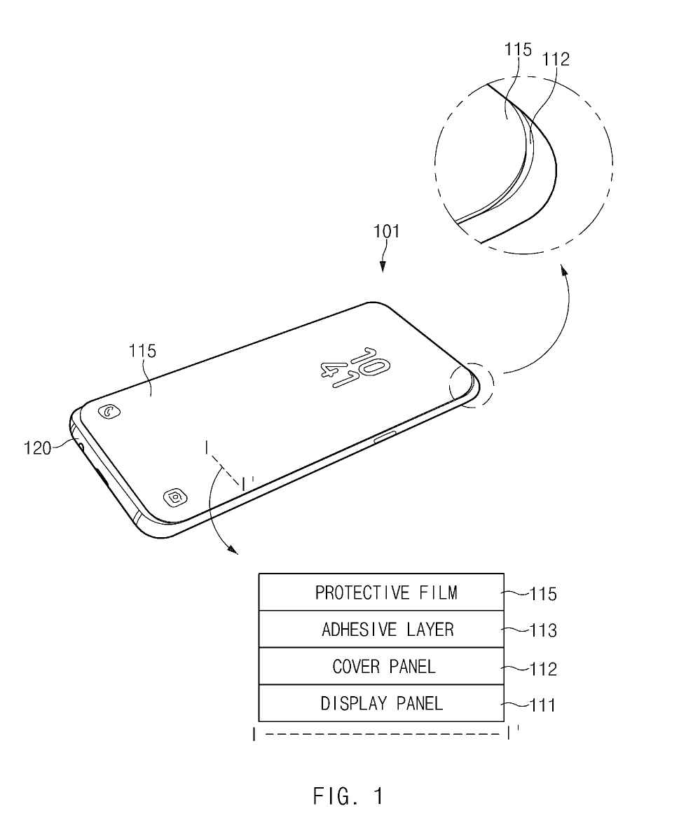

FIG. 1 illustrates an electronic device having a protective film attached thereto according to various embodiments.

Referring to FIG. 1, an electronic device 101 may include a display panel 111, a cover panel (e.g., a glass cover) 112, an adhesive layer 113, a protective film 115, and a side member (or a side housing) 120.

According to various embodiments, in a sectional view taken along line I-I′, the electronic device 101 may include the display panel 111, the cover panel (e.g., a glass cover) 112, the adhesive layer 113, and the protective film 115. The display panel 111 may further include various layers (e.g., a touch panel, a polarization layer, a rear protective layer, and the like) therein although the layers are not illustrated in FIG. 1.

According to various embodiments, the display panel 111 may include, for example, a liquid crystal display (LCD), a light-emitting diode (LED) display, an organic light-emitting diode (OLED) display, a microelectromechanical systems (MEMS) display, or an electronic paper display. The display panel 111 may display various types of contents (e.g., text, images, videos, icons, symbols, and/or the like) to a user. The display panel 111 may include a touch screen and may receive, for example, a touch, gesture, proximity, or hovering input using an electronic pen or a part of the user's body.

According to various embodiments, the display panel 111 may be implemented in a flat form or in a form in which a portion of a side surface is curved (e.g., convex toward the outside). The display panel 111 may be implemented with a liquid crystal display (LCD), a light-emitting diode (LED) display, or an organic light-emitting diode (OLED) display. Alternatively, the display panel 111 may be implemented in a flexible or foldable form. In this case, the display panel 111 may be implemented with an organic light-emitting diode (OLED) or a polymer material (e.g., polyimide (PI)).

According to various embodiments, the cover panel (e.g., a glass cover) 112 may protect the display panel 111 inward of the cover panel 112. The cover panel 112 may be implemented with a transparent material. The cover panel 112 may pass light output from the display panel 111 inward of the cover panel 112. For example, the cover panel 112 may be implemented with a material, such as glass, an acrylic resin, a laminate of an acrylic resin and polycarbonate (PC), or the like. In an embodiment, in the case where the electronic device 101 is implemented in a flexible or foldable form, the cover panel 112 may be implemented with a sheet of thin glass, polyimide (PI), polyethylene naphthalate (PEN), polyethylene terephthalate (PET), urethane thermoplastic elastomer (TPU), or the like.

According to various embodiments, the adhesive layer (or a pressure sensitive adhesive “PSA” layer) 113 may be disposed between the protective film 115 and the cover panel 112. The adhesive layer 113 may stick the cover panel 112 and the protective film 115 under the action of pressure (a pressing force) at room temperature.

In an embodiment, the adhesive layer 113 may be implemented with a silicone-based material. The adhesive layer 113 of a silicone-based material may be advantageous for removal of bubbles or natural attachment since the adhesive layer 113 is excellent in wetting (wettability or spreadability). Furthermore, since the adhesive layer 113 of a silicone-based material is excellent in reworkability, foreign matter may not be left when the adhesive layer 113 is removed, and the adhesive layer 113 may have high heat-resistance.

In another embodiment, the adhesive layer 113 may be implemented with an acrylic material. The acrylic adhesive layer 113 may easily increase an adhesive force, compared with a silicone-based adhesive layer. The acrylic adhesive layer 113 may be used in the case where it is permanently used in an adhesive state without rework.

According to various embodiments, the protective film 115 may be a layer that protects the cover panel 112 and obstructs adhesion of water, oil, foreign matter, or the like from the outside. The protective film 115 may have anti-fingerprint characteristics (e.g., a property in that water or oil is easily cleaned from the protective film 115, a property in that a fingerprint mark is not clearly visible, or a property in that a part (e.g., a finger) of a user's body slides well over the protective film 115). The protective film 115 may prevent foreign matter, such as water, oil, or the like, from adhering to the surface thereof, or may allow stuck foreign matter to be easily separated from the surface, in the process in which the user uses the electronic device 101.

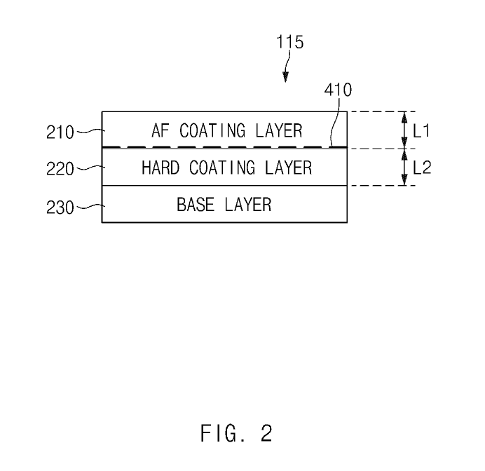

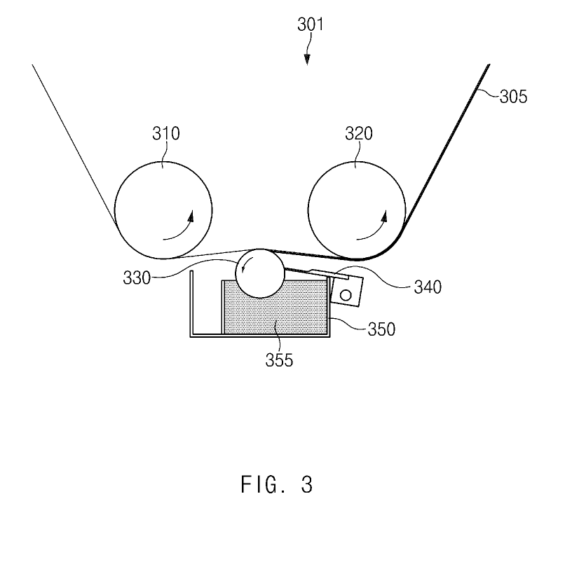

According to various embodiments, the protective film 115 may be manufactured through a micro gravure process. The micro gravure process may be a method of forming an AF coating layer by feeding hard-coated fabric in a roller form into a micro gravure apparatus. Additional information about a configuration of the protective film 115 may be provided through FIG. 2. Additional information about the micro gravure process may be provided through FIGS. 3 to 5.

While FIG. 1 illustrates that the protective film 115 is attached to a front surface of the electronic device 101, the present disclosure is not limited thereto. For example, the protective film 115 may also be attached to a side surface or a rear surface of the electronic device 101. For example, the protective film 115 may be attached to a back cover of the electronic device 101 through a manufacturing process, or may be separately attached to the back cover by the user.

The side member (or a main body or a side housing) 120 may have a form that surrounds the space between a first surface of the electronic device 101 (e.g., a surface on which contents are output through the display panel 111) and a second surface facing away from the first surface (e.g., a surface to which the back cover is attached). The display panel 111 and various components (e.g., a camera module, a physical button, a sensor window, and the like) around the display panel 111 may be mounted in the side housing 120. The side housing 120 may include various components (e.g., a processor, a communication circuit, a PCB, a battery, and the like) therein for driving the electronic device 101.

FIG. 2 illustrates a configuration of the protective film according to various embodiments.

Referring to FIG. 2, the protective film 115 may include an AF coating layer 210, a hard coating layer 220, and a base layer 230. For example, the protective film 115 may be formed by coating a surface of the base layer 230 with the hard coating layer 220, and then coating the hard coating layer 220 with the AF coating layer 210.

The AF coating layer 210 may be disposed to accept direct contact with a user's skin (e.g., a finger, the face, or the like) whenever the user utilizes the electronic device 101. Accordingly, the AF coating layer 210 may be implemented to include anti-fingerprint characteristics which resist the leaving of fingerprint mark (water or oil) on a surface thereof.

According to an embodiment, the thickness L1 of the AF coating layer 210 may be, for example, about 80 nm to about 200 nm. The thickness L1 of the AF coating layer 210 may vary depending on a method of forming the AF coating layer 210. For example, in the case where the AF coating layer 210 is formed through a micro gravure process, the AF coating layer 210 may be formed by rotating a gravure roller having an intaglio structure. In this case, an AF coating solution may have a specified viscosity (e.g., 4 centipoise “CPS” or more) such that the AF coating solution is efficiently adsorbed onto the gravure roller.

Additional information about forming the AF coating layer 210 through the micro gravure process may be provided through FIGS. 3 to 5.

According to an embodiment, the thickness L1 of the AF coating layer 210 may be a value between 1/100 and 1/15 of the thickness L2 of the hard coating layer 220.

According to various embodiments, the AF coating layer 210 may have a wiping property above specified performance (e.g., a property in that water or oil is easily cleaned from the protective film 115). The AF coating layer 210 may have, for example, a water contact angle of 110 degrees or more. The water contact angle may be an angle that a surface of solid to which moisture adheres and a surface of water make. Moisture adhering to the AF coating layer 210 may be more easily cleaned with an increase in the water contact angle.

According to various embodiments, the AF coating layer 210 may have an excellent slippage property (a property in that a part (e.g., a finger) of a user's body slides well over the protective film 115). The AF coating layer 210 may have, for example, a coefficient of friction of 0.2 or less.

According to various embodiments, the AF coating layer 210 may have durability of a specified level or higher. For example, the AF coating layer 210 may maintain a water contact angle of 95 degrees or more after a rubbing test at 1 Kg and 3000 cycles.

According to various embodiments, the hard coating layer 220 may protect the base layer 230. The hard coating layer 220 may prevent the base layer 230 from being damaged (e.g., worn down) by scratches or other forceful contacts caused by application of external force. The hard coating layer 220 may thus have include a requisitely high degree of hardness and may be bonded with the AF coating layer 210. The hard coating layer 220 may be formed of an acrylic material. In an embodiment, the thickness L2 of the hard coating layer 220 may be about 3 μm to about 20 μm.

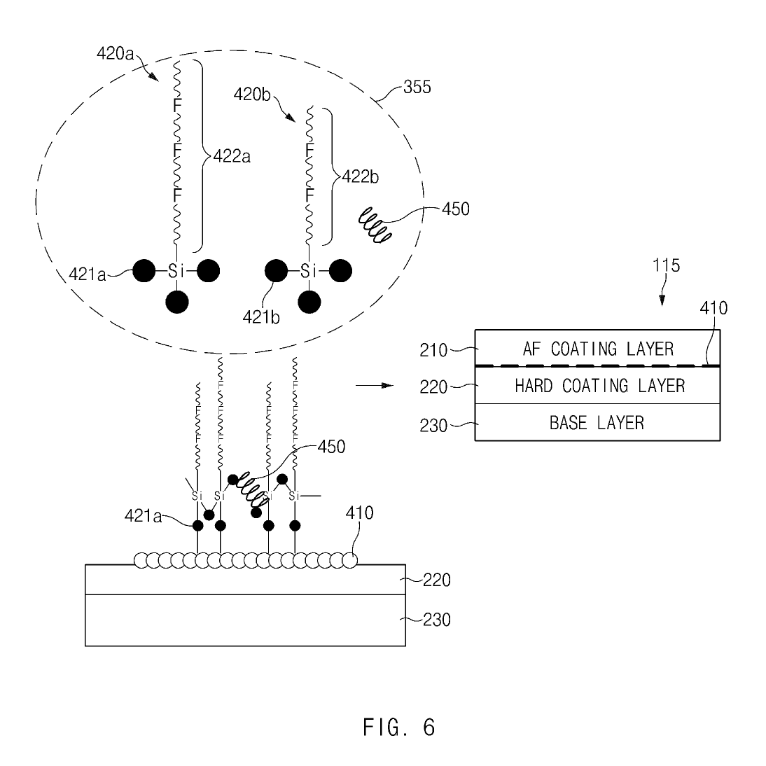

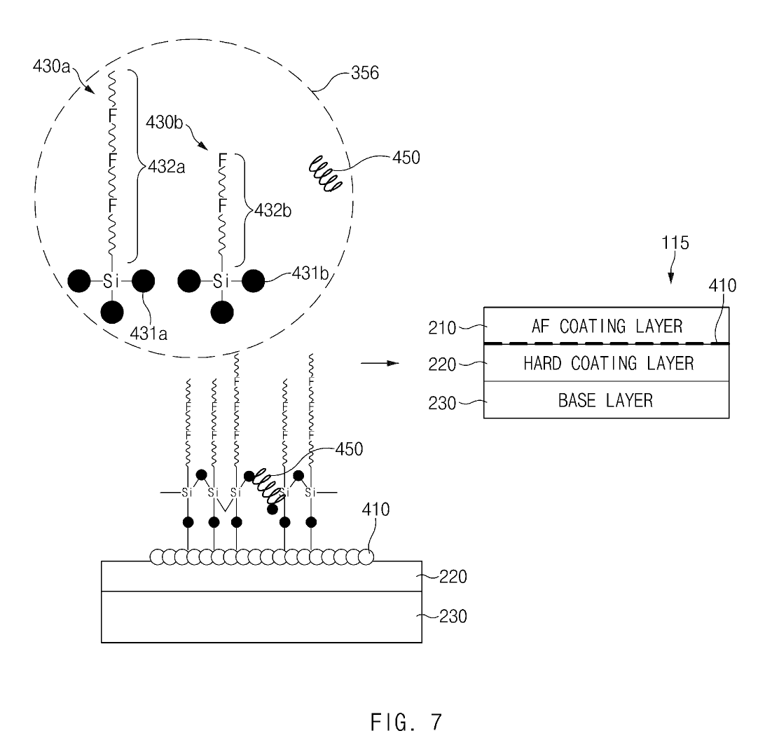

According to various embodiments, the protective film 115 may include a primer 410 disposed between the AF coating layer 210 and the hard coating layer 220. The primer 410 may include functional groups that are easily bonded with the hard coating layer 220. The primer 410 may strengthen the bonding force between the AF coating layer 210 and the hard coating layer 220. Additional information about the primer 410 may be provided through FIGS. 6 and 7.

According to various embodiments, the base layer 230 may be formed through a film or a sheet. While FIG. 2 illustrates that the base layer 230 has a thickness similar to those of the other layers, the base layer 230 may occupy most of the protective film 115.

According to an embodiment, the base layer 230 may be implemented with a film including at least one of polyethylene terephthalate (PET), polypropylene, case polypropylene (CPP), polyurethane, polyolefine, and polyimide (PI).

According to another embodiment, the base layer 230 may be implemented with a sheet including at least one of polycarbonate (PC), polymethylmethacrylate (PMMA), and a laminate of PC and PMMA.

FIG. 3 illustrates a micro gravure apparatus for executing AF coating according to various embodiments.

Referring to FIG. 3, a micro gravure apparatus 301 may include a first guide roller 310, a second guide roller 320, a gravure roller 330, a doctor blade 340, and a solution bath 350.

According to various embodiments, the first guide roller 310 and the second guide roller 320 may rotate which moves the fabric 305. The first guide roller 310 may feed the fabric 305 into the micro gravure apparatus 301. The second guide roller 320 may move the fabric 305 roller out of the micro gravure apparatus 301 after AF coating is completed by the gravure roller 330. The first guide roller 310 and the second guide roller 320 may be implemented as to rotate in the same direction. For example, both the first guide roller 310 and the second guide roller 320 may rotate in a counterclockwise direction, at the same rotation speed.

According to various embodiments, the fabric 305 may have a form in which a hard coating layer (e.g., the hard coating layer 220 of FIG. 2) is coated on a base layer (e.g., the base layer 230 of FIG. 2) before the fabric 305 is fed into the micro gravure apparatus 301. For example, the base layer may be a film or sheet, and the hard coating layer may be implemented with an acrylic material. The fabric 305 may be fed into the micro gravure apparatus 301 such that a hard-coated surface (hereinafter, referred to as a first surface) faces the gravure roller 330 and an opposite surface (hereinafter, referred to as a second surface) faces the first guide roller 310 and the second guide roller 320.

According to various embodiments, the gravure roller 330 may be disposed between the first guide roller 310 and the second guide roller 320. The gravure roller 330 may rotate in the same direction as the rotating direction of the first guide roller 310 and the second guide roller 320. For example, in the case where the first guide roller 310 and the second guide roller 320 rotate in the counterclockwise direction, the gravure roller 330 may also rotate in the counterclockwise direction.

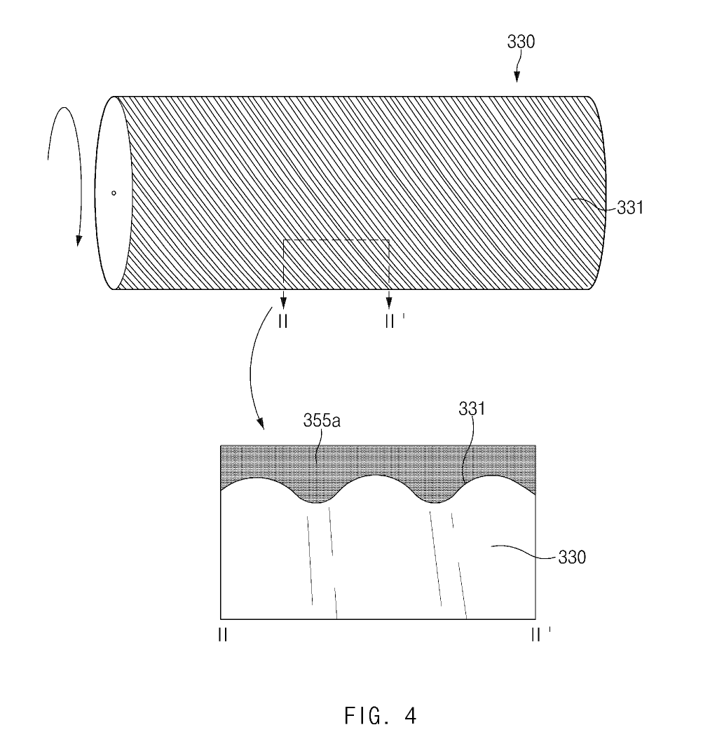

According to various embodiments, the gravure roller 330 may have an intaglio structure (or a bumpy structure) on the surface thereof. A portion of an AF coating solution 355 may be received in the intaglio structure as the gravure roller 330 rotates. Additional information about the intaglio structure of the gravure roller 330 may be provided through FIG. 4.

According to various embodiments, the gravure roller 330 may be disposed such that at least a portion thereof is submerged in the AF coating solution 355. The AF coating solution 355 received in the intaglio structure may be coated on the first surface of the fabric 305 as the gravure roller 330 rotates.

According to various embodiments, the doctor blade 340 may have a metal plate form. The doctor blade 340 may be disposed in an area where the gravure roller 330 rotates to escape from the solution bath 350. The doctor blade 340 may flatten the AF coating solution 355 adsorbed onto the surface of the gravure roller 330. The coating thickness of the adsorbed AF coating solution 355 may be adjusted by the distance between the doctor blade 340 and the gravure roller 330.

According to various embodiments, the solution bath 350 may receive the AF coating solution 355 therein. The gravure roller 330 may be disposed such that a portion thereof is submerged in the AF coating solution 355 in the solution bath 350.

According to various embodiments, the AF coating solution 355 may have a specified viscosity (e.g., 4 CPS) or more. In the case where the AF coating solution 355 has a low viscosity, the amount of the AF coating solution 355 adsorbed onto the rotating gravure roller 330 may be insufficient, and therefore the AF coating layer may not be effectively formed.

For example, in the case where the AF coating solution 355 has a viscosity of 4 CPS or more, the AF coating solution 355 may be conveyed to the first surface of the fabric 305 by the gravure roller 330, and an AF coating layer with a thickness of about 80 nm to about 200 nm may be formed.

According to an embodiment, the viscosity of the AF coating solution 355 may increase in the case where the ratio of solid contents contained in the AF coating solution 355 increases or a fluorine solute with high molecular weight is used. According to another embodiment, the viscosity of the AF coating solution 355 may be increased by raising thixotropy (stickiness) by adjusting the concentration of a slow drying solvent, or by using a co-solvent of a slow drying solvent and a fast drying solvent.

According to various embodiments, the AF coating solution 355 may be a solution with relatively low volatility. A micro gravure process may be performed by using the AF coating solution 355 received for a long time in the solution bath 350 that is open to the outside. In the case where the AF coating solution 355 has low volatility, the AF coating layer 210 may be efficiently formed.

FIG. 4 illustrates an intaglio structure of an example gravure roller according to various embodiments.

Referring to FIG. 4, the gravure roller 330 may include an intaglio structure (or a bumpy structure or a groove structure) 331 formed on a surface thereof. The intaglio structure 331 may be formed as to include an incline at a predetermined angle with respect to the rotational direction of the gravure roller 330. The form of the intaglio structure 331 in FIG. 4 is merely illustrative, and the present disclosure is not limited thereto. The form (e.g., shape, depth, width, extension direction, or the like) of the intaglio structure 331 may be implemented differently according to, for example, a type or a characteristic (e.g., viscosity) of the AF coating solution 355.

In a sectional view taken along line the intaglio structure 331 of the gravure roller 330 may be submerged in an AF coating solution (e.g., the AF coating solution 355 of FIG. 3) and may thus be filled with the AF coating solution 355a when the gravure roller 330 rotates. The thickness of the AF coating solution 355a adsorbed onto the intaglio structure 331 may be adjusted by a doctor blade (e.g., the doctor blade 340 of FIG. 3). The adsorbed AF coating solution 355a may be flattened by the doctor blade 340.

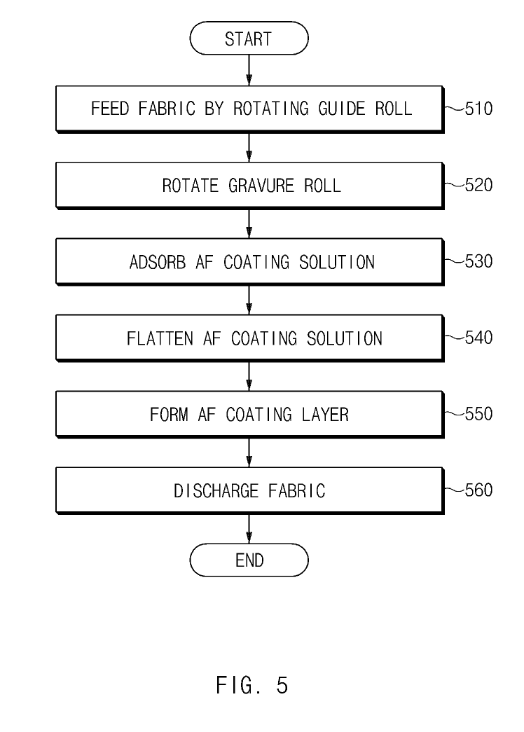

FIG. 5 is a flowchart illustrating a micro gravure process according to various embodiments.

Referring to FIG. 5, in operation 510, a micro gravure apparatus (e.g., the micro gravure apparatus 301 of FIG. 3) may rotate a first guide roller (e.g., the first guide roller 310 of FIG. 3) and a second guide roller (e.g., the second guide roller 320 of FIG. 3) in order to feed (or move) hard-coated fabric (e.g., the fabric 305 of FIG. 3) into the micro gravure apparatus 301. The fabric 305 may be arranged such that a first surface on which a hard coating layer (e.g., the hard coating layer 220 of FIG. 2) is formed faces the gravure roller 330 and a second surface opposite to the first surface faces the first guide roller 310 and the second guide roller 320. The micro gravure apparatus 301 may allow the fabric 305 to pass between the guide rollers (the first guide roller 310 and the second guide roller 320) and the gravure roller 330.

In operation 520, the gravure roller 330, according to an embodiment, may rotate in the same direction as the guide rollers (the first guide roller 310 and the second guide roller 320). At least a portion of the gravure roller 330 may be submerged in the AF coating solution 355 in the solution bath 350.

In operation 530, according to an embodiment, an AF coating solution (e.g., the AF coating solution 355 of FIG. 3) may be adsorbed onto an intaglio structure (e.g., the intaglio structure 331 of FIG. 4) of the gravure roller 330 that is submerged in a solution bath (e.g., the solution bath 350 of FIG. 3). The intaglio structure 331 onto which the AF coating solution 355 is adsorbed may submerge into and emerge out of the solution bath 350 as the gravure roller 330 rotates and continues feeding the hard-coated fabric.

In operation 540, according to an embodiment, a doctor blade (e.g., the doctor blade 340 of FIG. 3) may flatten the AF coating solution 355 adsorbed onto the surface of the gravure roller 330. The coating thickness of the adsorbed AF coating solution 355 may be adjusted by the distance between the doctor blade 340 and the gravure roller 330.

In operation 550, according to an embodiment, the intaglio structure 331 onto which the AF coating solution 355 is adsorbed may contact the first surface of the fabric 305 as the gravure roller 330 additionally rotates. At least a portion of the AF coating solution (e.g., the adsorbed AF coating solution 355a of FIG. 4) adsorbed onto the gravure roller 330 may be adsorbed onto the first surface of the fabric 305, resulting in formation and application of an AF coating layer (e.g., the AF coating layer 210 of FIG. 2).

In operation 560, according to an embodiment, the remaining fabric 305 (which previously included the deposit of the AF coating layer 210 formed thereon) may remove from the micro gravure apparatus 301 as the first guide roller 310 and the second guide roller 320 continue to rotate.

According to various embodiments, the AF coating layer 210 formed by the micro gravure method may have a thickness of a specified value (e.g., 80 nm or more). In the case where the AF coating layer 210 is formed by the micro gravure process, the AF coating solution 355 may be received in the solution bath 350, which may be exposed to the environment (e.g., that is open to the outside). The AF coating solution 355 may have relatively low volatility and high viscosity (e.g., 4 CPS). The coating thickness of the AF coating solution 355 on the surface of the gravure roller 330 may be adjusted by configuration of the distance between the doctor blade 340 and the rotating gravure roller 330. The doctor blade 340 and the gravure roller 330 may contact each other, or may be separated from each other by some minimum distance, and the AF coating layer 210 may have a thickness of about 80 nm. In the case where the thickness L1 of the AF coating layer 210 is 80 nm or more, the anti-fingerprint characteristics of the AF coating layer 210 and the durability of the protective film 115 may be enhanced compared to cases where the thickness L1 is less than 80 nm.

According to various embodiments, the AF coating layer 210 formed by the micro gravure process may have a thickness of a specified value (e.g., 200 nm) or less. In the case where the AF coating layer 210 is made thick (e.g., more than 200 nm) by repeating AF coating of a micro gravure type, production cost may rise and appearance quality, such as leveling (or coating flatness), may be deteriorated due to the nature of a transparent material.

According to various embodiments, the AF coating layer 210 formed by the micro gravure process may have a thickness between about 110 nm and about 150 nm. In this case, the AF coating layer 210 may have a wiping property of a predetermined level (e.g., a water contact angle of about 115 degrees or more) and durability (e.g., a water contact angle change of about 10 degrees or less when a rubbing test is conducted at 1 Kg and 3000 cycles or more with respect to a reciprocating motion of 40 cycles per minute). Furthermore, in this case, the AF coating layer 210 may have chemical resistance of a predetermined level (e.g., a water contact angle change of about 10 degrees or less when a rubbing test is conducted with 99.9 percent pure ethyl alcohol at 1 Kg and 3000 cycles or more with respect to a reciprocating motion of 40 cycles per minute).

According to various embodiments, a method for manufacturing a protective film may include moving fabric having a hard-coated first surface by rotating a first guide roller and a second guide roller, filling an intaglio structure of a gravure roller with an anti-fingerprint coating solution by rotating the gravure roller, flattening the AF coating solution adsorbed onto the gravure roller, and adsorbing at least a portion of the flattened AF coating solution onto the first surface of the fabric by rotating the gravure roller.

According to various embodiments, the moving of the hard-coated fabric may include arranging the fabric such that the first surface faces the gravure roller and a second surface opposite to the first surface faces the first guide roller and the second guide roller.

According to various embodiments, the filling of the intaglio structure with the AF coating solution may include submerging at least a portion of the gravure roller in the AF coating solution with a viscosity of 4 centipoise (CPS) or more.

According to various embodiments, the adsorbing of the at least a portion of the flattened AF coating solution onto the first surface may include creating the AF coating layer that forms a water contact angle of 110 degrees or more with moisture adsorbed onto the first surface from the outside.

FIG. 6 illustrates a chemical bond of an AF coating layer according to various embodiments. It is understood that FIG. 6 is merely illustrative, and the present disclosure is not limited thereto.

Referring to FIG. 6, the protective film 115 may include the AF coating layer 210, the hard coating layer 220, and the base layer 230. The AF coating layer 210 may be formed on the hard coating layer 220 through the micro gravure apparatus 301, with the hard coating layer 220 formed on the base layer 230.

According to various embodiments, the primer 410 may be bonded to at least a portion of the hard coating layer 220 before the AF coating layer 210 is formed. The primer 410 may include functional groups that are easily bonded with the hard coating layer 220. The functional groups may increase the bonding force between the hard coating layer 220 and the primer 410.

The primer 410 may have the same linking functional groups as the fluorine compounds 420a and 420b contained in the AF coating solution 355. The linking functional groups may increase the bonding force between the fluorine compounds 420a and 420b and the primer 410. In an embodiment, the primer 410 may adhere to the hard coating layer 220 through a separate gravure process.

The AF coating solution 355 may include the fluorine compounds 420a and 420b and an adhesion promoter 450.

The fluorine compounds 420a and 420b may include linking functional groups 421a and 421b and perfluoro chains 422a and 422b. The linking functional groups 421a and 421b may be functional groups that are the same as the primer 410, and may be bonded to the primer 410. The perfluoro chains 422a and 422b may be arranged so as to face away from the primer 410, and may allow the formed AF coating layer 210 to have anti-fingerprint characteristics.

The adhesion promoter 450 may be bonded between the first fluorine compound 420a and the second fluorine compound 420b. The adhesion promoter 450 may strengthen the bonding force between the first fluorine compound 420a and the second fluorine compound 420b.

FIG. 7 illustrates a bond of an AF coating solution including a low-refractivity fluorine chain according to various embodiments.

Referring to FIG. 7, an AF coating solution 356 may include a first fluorine compound 430a including a perfluoro chain 432a and a second fluorine compound 430b including a low-refractivity fluorine chain 432b, unlike the AF coating solution 355 of FIG. 6.

The first fluorine compound 430a may include a linking functional group 431a and the perfluoro chain 432a. The linking functional group 431a may be a functional group that is the same as the primer 410, and may be bonded to the primer 410. The perfluoro chain 422a may be arranged to face away from the primer 410 and may facilitate the AF coating layer 210 having anti-fingerprint characteristics.

The second fluorine compound 430b may include a linking functional group 431b and the low-refractivity fluorine chain 432b. The linking functional group 431b may be a functional group that is the same as the primer 410, and may be bonded to the primer 410. The low-refractivity fluorine chain 432b may be arranged so as to face away from the primer 410. The low-refractivity fluorine chain 432b may have a lower refractive index for light than the perfluoro chain 422a and may reduce interfacial reflection correspondingly. As a result, the low-refractivity fluorine chain 432b may lower fingerprint visibility for the AF coating layer 210. In the case where a fingerprint mark (e.g., water or oil) is present on the AF coating layer 210, the low-refractivity fluorine chain 432b may reduce interfacial reflection, rendering the fingerprint mark less visible to a user.

The adhesion promoter 450 may be bonded between the first fluorine compound 430a and the second fluorine compound 430b. The adhesion promoter 450 may strengthen the bonding force between the first fluorine compound 430a and the second fluorine compound 430b.

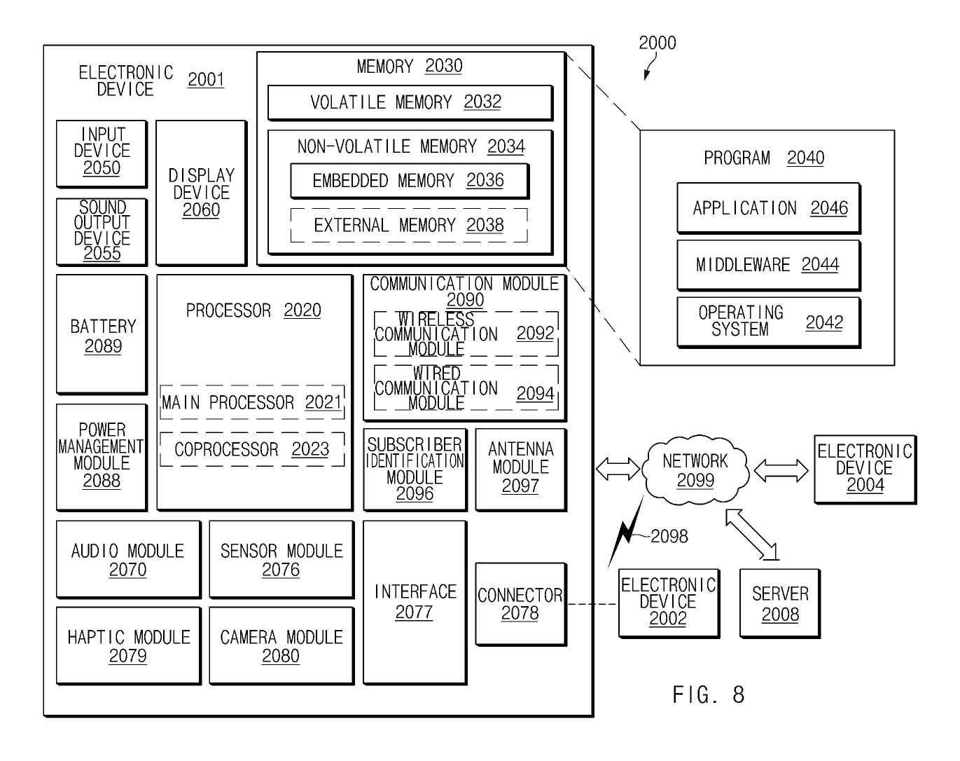

FIG. 8 illustrates a block diagram of an electronic device (e.g., the electronic device in FIG. 1) 2001 in a network environment 2000, according to various embodiments. An electronic device according to various embodiments of this disclosure may include various forms of devices. For example, the electronic device may include at least one of, for example, portable communication devices (e.g., smartphones), computer devices (e.g., personal digital assistants (PDAs), tablet personal computers (PCs), laptop PCs, desktop PCs, workstations, or servers), portable multimedia devices (e.g., electronic book readers or Motion Picture Experts Group (MPEG-1 or MPEG-2) Audio Layer 3 (MP3) players), portable medical devices (e.g., heartbeat measuring devices, blood glucose monitoring devices, blood pressure measuring devices, and body temperature measuring devices), cameras, or wearable devices. The wearable device may include at least one of an accessory type (e.g., watches, rings, bracelets, anklets, necklaces, glasses, contact lens, or head-mounted-devices (HMDs)), a fabric or garment-integrated type (e.g., an electronic apparel), a body-attached type (e.g., a skin pad or tattoos), or a bio-implantable type (e.g., an implantable circuit). According to various embodiments, the electronic device may include at least one of, for example, televisions (TVs), digital versatile disk (DVD) players, audios, audio accessory devices (e.g., speakers, headphones, or headsets), refrigerators, air conditioners, cleaners, ovens, microwave ovens, washing machines, air cleaners, set-top boxes, home automation control panels, security control panels, game consoles, electronic dictionaries, electronic keys, camcorders, or electronic picture frames.

In another embodiment, the electronic device may include at least one of navigation devices, satellite navigation system (e.g., Global Navigation Satellite System (GNSS)), event data recorders (EDRs) (e.g., black box for a car, a ship, or a plane), vehicle infotainment devices (e.g., head-up display for vehicle), industrial or home robots, drones, automatic teller's machines (ATMs), points of sales (POSs), measuring instruments (e.g., water meters, electricity meters, or gas meters), or internet of things (e.g., light bulbs, sprinkler devices, fire alarms, thermostats, or street lamps). The electronic device according to an embodiment of this disclosure may not be limited to the above-described devices, and may provide functions of a plurality of devices like smartphones which has measurement function of personal biometric information (e.g., heart rate or blood glucose). In this disclosure, the term “user” may refer to a person who uses an electronic device or may refer to a device (e.g., an artificial intelligence electronic device) that uses the electronic device.

Referring to FIG. 9, under the network environment 2000, the electronic device 2001 (e.g., the electronic device 101) may communicate with an electronic device 2002 through local wireless communication by the first network 2098 or may communication with an electronic device 2004 or a server 2008 through a network 2099. According to an embodiment, the electronic device 2001 may communicate with the electronic device 2004 through the server 2008.

According to an embodiment, the electronic device 2001 may include a bus 2010, a processor 2020, a memory 2030, an input device 2050 (e.g., a micro-phone or a mouse), a sound output device 2055, a display device 2060, an audio module 2070, a sensor module 2076, an interface 2077, a haptic module 2079, a camera module 2080, a power management module 2088, a battery 2089, a communication module 2090, a subscriber identification module 2096, antenna module 2097. According to an embodiment, the electronic device 2001 may not include at least one (e.g., the display device 2060 or the camera module 2080) of the above-described elements or may further include other element(s).

The bus 2010 may interconnect the above-described elements 2020 to 2090 and may include a circuit for conveying signals (e.g., a control message or data) between the above-described elements. The processor 2020 may include one or more of a central processing unit (CPU), an application processor (AP), a graphic processing unit (GPU), an image signal processor (ISP) of a camera or a communication processor (CP). According to an embodiment, the processor 2020 may be implemented with a system on chip (SoC) or a system in package (SiP). For example, the processor 2020 may drive an operating system (OS) or an application to control at least one of another element (e.g., hardware or software element) connected to the processor 2020 and may process and compute various data. The processor 2020 may load a command or data, which is received from at least one of other elements (e.g., the communication module 2090), into a volatile memory 2032 to process the one or more instructions or data and may store the result data into a nonvolatile memory 2034. According to an embodiment, the processor 2020 may include main processor 2021 and coprocessor 2023.

The memory 2030 may include, for example, the volatile memory 2032 or the nonvolatile memory 2034. The volatile memory 2032 may include, for example, a random access memory (RAM) (e.g., a dynamic RAM (DRAM), a static RAM (SRAM), or a synchronous DRAM (SDRAM)). The nonvolatile memory 2034 may include, for example, an one time programmable read-only memory (OTPROM), a programmable read-only memory (PROM), an erasable PROM (EPROM), an electrically EPROM (EEPROM), a mask ROM, a flash ROM, a flash memory, a hard disk drive (HDD), or a solid-state drive (SSD). In addition, the nonvolatile memory 2034 may be configured in the form of an embedded memory 2036 or the form of an external memory 2038 which is available through connection if requested, according to the connection with the electronic device 2001. The external memory 2038 may further include a flash drive such as compact flash (CF), secure digital (SD), micro secure digital (Micro-SD), mini secure digital (Mini-SD), extreme digital (xD), a multimedia card (MMC), or a memory stick. The external memory 2038 may be operatively or physically connected with the electronic device 2001 in a wired manner (e.g., a cable or a universal serial bus (USB)) or a wireless (e.g., Bluetooth) manner.

For example, the memory 2030 may store, for example, at least one different software element, such as one or more instructions or data associated with the program 2040, of the electronic device 2001. The program 2040 may include, for example, an operating system 2042, middleware 2044, or an application program (interchangeably, “application”) 2046.

The input device 2050 may include a microphone, a mouse, or a keyboard. According to an embodiment, the keyboard may include a keyboard physically connected or a virtual keyboard displayed through the display 2060.

The display 2060 may include a display, a hologram device or a projector, and a control circuit to control a relevant device. The display may include, for example, a liquid crystal display (LCD), a light emitting diode (LED) display, an organic LED (OLED) display, a microelectromechanical systems (MEMS) display, or an electronic paper display. According to an embodiment, the display may be flexibly, transparently, or wearably implemented. The display may include a touch circuitry, which is able to detect a user's input such as a gesture input, a proximity input, or a hovering input or a pressure sensor (interchangeably, a force sensor) which is able to measure the intensity of the pressure by the touch. The touch circuit or the pressure sensor may be implemented integrally with the display or may be implemented with at least one sensor separately from the display. The hologram device may show a stereoscopic image in a space using interference of light. The projector may project light onto a screen to display an image. The screen may be located inside or outside the electronic device 2001.

The audio module 2070 may convert, for example, from a sound into an electrical signal or from an electrical signal into the sound. According to an embodiment, the audio module 2070 may acquire sound through the input device 2050 (e.g., a microphone) or may output sound through an output device (not illustrated) (e.g., a speaker or a receiver) included in the electronic device 2001, an external electronic device (e.g., the electronic device 2002 (e.g., a wireless speaker or a wireless headphone)) or an electronic device 2006 (e.g., a wired speaker or a wired headphone) connected with the electronic device 2001

The sensor module 2076 may measure or detect, for example, an internal operating state (e.g., power or temperature) of the electronic device 2001 or an external environment state (e.g., an altitude, a humidity, or brightness) to generate an electrical signal or a data value corresponding to the information of the measured state or the detected state. The sensor module 2076 may include, for example, at least one of a gesture sensor, a gyro sensor, a barometric pressure sensor, a magnetic sensor, an acceleration sensor, a grip sensor, a proximity sensor, a color sensor (e.g., a red, green, blue (RGB) sensor), an infrared sensor, a biometric sensor (e.g., an iris sensor, a fingerprint senor, a heartbeat rate monitoring (HRM) sensor, an e-nose sensor, an electromyography (EMG) sensor, an electroencephalogram (EEG) sensor, an electrocardiogram (ECG) sensor), a temperature sensor, a humidity sensor, an illuminance sensor, or an UV sensor. The sensor module 2076 may further include a control circuit for controlling at least one or more sensors included therein. According to an embodiment, the sensor module 2076 may be controlled by using the processor 2020 or a processor (e.g., a sensor hub) separate from the processor 2020. In the case that the separate processor (e.g., a sensor hub) is used, while the processor 2020 is in a sleep state, the separate processor may operate without awakening the processor 2020 to control at least a portion of the operation or the state of the sensor module 2076.

According to an embodiment, the interface 2077 may include a high definition multimedia interface (HDMI), a universal serial bus (USB), an optical interface, a recommended standard 232 (RS-232), a D-subminiature (D-sub), a mobile high-definition link (MHL) interface, a SD card/MMC (multi-media card) interface, or an audio interface. A connector 2078 may physically connect the electronic device 2001 and the electronic device 2006. According to an embodiment, the connector 2078 may include, for example, an USB connector, an SD card/MMC connector, or an audio connector (e.g., a headphone connector).

The haptic module 2079 may convert an electrical signal into mechanical stimulation (e.g., vibration or motion) or into electrical stimulation. For example, the haptic module 2079 may apply tactile or kinesthetic stimulation to a user. The haptic module 2079 may include, for example, a motor, a piezoelectric element, or an electric stimulator.

The camera module 2080 may capture, for example, a still image and a moving picture. According to an embodiment, the camera module 2080 may include at least one lens (e.g., a wide-angle lens and a telephoto lens, or a front lens and a rear lens), an image sensor, an image signal processor, or a flash (e.g., a light emitting diode or a xenon lamp).

The power management module 2088, which is to manage the power of the electronic device 2001, may implement at least a portion of a power management integrated circuit (PMIC).

The battery 2089 may include a primary cell, a secondary cell, or a fuel cell and may be recharged by an external power source to supply power at least one element of the electronic device 2001.

The communication module 2090 may establish a communication channel between the electronic device 2001 and an external device (e.g., the first external electronic device 2002, the second external electronic device 2004, or the server 2008). The communication module 2090 may support wired communication or wireless communication through the established communication channel. According to an embodiment, the communication module 2090 may include a wireless communication module 2092 or a wired communication module 2094. The communication module 2090 may communicate with the external device (e.g., the first external electronic device 2002, the second external electronic device 2004, or the server 2008) through a first network 2098 (e.g. a wireless local area network such as Bluetooth or infrared data association (IrDA)) or a second network 2099 (e.g., a wireless wide area network such as a cellular network) through a relevant module among the wireless communication module 2092 or the wired communication module 2094.

The wireless communication module 2092 may support, for example, cellular communication, local wireless communication, global navigation satellite system (GNSS) communication. The cellular communication may include, for example, long-term evolution (LTE), LTE Advance (LTE-A), code division multiple access (CMA), wideband CDMA (WCDMA), universal mobile telecommunications system (UMTS), wireless broadband (WiBro), or global system for mobile communications (GSM). The local wireless communication may include wireless fidelity (Wi-Fi), WiFi Direct, light fidelity (Li-Fi), Bluetooth, Bluetooth low energy (BLE), Zigbee, near field communication (NFC), magnetic secure transmission (MST), radio frequency (RF), or a body area network (BAN). The GNSS may include at least one of a global positioning system (GPS), a global navigation satellite system (Glonass), Beidou Navigation Satellite System (Beidou), the European global satellite-based navigation system (Galileo), or the like. In the present disclosure, “GPS” and “GNSS” may be interchangeably used.

According to an embodiment, when the wireless communication module 2092 supports cellar communication, the wireless communication module 2092 may, for example, identify or authenticate the electronic device 2001 within a communication network using the subscriber identification module (e.g., a SIM card) 2096. According to an embodiment, the wireless communication module 2092 may include a communication processor (CP) separate from the processor 2020 (e.g., an application processor (AP)). In this case, the communication processor may perform at least a portion of functions associated with at least one of elements 2010 to 2096 of the electronic device 2001 in substitute for the processor 2020 when the processor 2020 is in an inactive (sleep) state, and together with the processor 2020 when the processor 2020 is in an active state. According to an embodiment, the wireless communication module 2092 may include a plurality of communication modules, each supporting a relevant communication scheme among cellular communication, local wireless communication, or a GNSS communication.

The wired communication module 2094 may include, for example, include a local area network (LAN) service, a power line communication, or a plain old telephone service (POTS).

For example, the first network 2098 may employ, for example, WiFi direct or Bluetooth for transmitting or receiving one or more instructions or data through wireless direct connection between the electronic device 2001 and the first external electronic device 2002. The second network 2099 may include a telecommunication network (e.g., a computer network such as a LAN or a WAN, the Internet or a telephone network) for transmitting or receiving one or more instructions or data between the electronic device 2001 and the second electronic device 2004.

According to various embodiments, the one or more instructions or the data may be transmitted or received between the electronic device 2001 and the second external electronic device 2004 through the server 2008 connected with the second network 2099. Each of the first and second external electronic devices 2002 and 2004 may be a device of which the type is different from or the same as that of the electronic device 2001. According to various embodiments, all or a part of operations that the electronic device 2001 will perform may be executed by another or a plurality of electronic devices (e.g., the electronic devices 2002 and 2004 or the server 2008). According to an embodiment, in the case that the electronic device 2001 executes any function or service automatically or in response to a request, the electronic device 2001 may not perform the function or the service internally, but may alternatively or additionally transmit requests for at least a part of a function associated with the electronic device 2001 to any other device (e.g., the electronic device 2002 or 2004 or the server 2008). The other electronic device (e.g., the electronic device 2002 or 2004 or the server 2008) may execute the requested function or additional function and may transmit the execution result to the electronic device 2001. The electronic device 2001 may provide the requested function or service using the received result or may additionally process the received result to provide the requested function or service. To this end, for example, cloud computing, distributed computing, or client-server computing may be used.

According to various embodiments, an electronic device includes a side member configured to surround a space between a first surface of the electronic device and a second surface facing away from the first surface, a display panel configured to output contents toward the first surface and disposed between the first surface and the second surface, a cover panel mounted on the display panel to protect the display panel, and a protective film mounted on the cover panel, such that the protective film includes a base layer disposed on the cover panel, a hard coating layer coated on the base layer, and an anti-fingerprint (AF) coating layer coated on the hard coating layer, and such that the AF coating layer has a thickness between 80 nm and 200 nm.

According to various embodiments, the AF coating layer forms a water contact angle of 110 degrees or more with moisture adsorbed onto the AF coating layer from the outside.

According to various embodiments, the AF coating layer is formed by curing a material with a viscosity of 4 centipoise (CPS) or more.

According to various embodiments, the protective film further includes a primer between the hard coating layer and the AF coating layer.

According to various embodiments, the AF coating layer includes polymers that contain the same functional group as the primer. The polymers contain a perfluoro chain. The polymers contain a perfluoro chain and a low-refractivity fluorine chain. The AF coating layer further includes an adhesion promoter bonded between the polymers.

According to various embodiments, the base layer is implemented with a film including at least one of polyethylene terephthalate (PET), polypropylene, case polypropylene (CPP), polyurethane, polyolefine, and polyimide.

According to various embodiments, the base layer is implemented with a sheet including at least one of polycarbonate (PC), polymethylmethacrylate (PMMA), and a laminate of PC and PMMA.

According to various embodiments, the display panel is implemented with at least one of a liquid crystal display (LCD), a light-emitting diode (LED) display, an organic light-emitting diode (OLED), and a polymer compound.

According to various embodiments, the cover panel is implemented with at least one of glass, an acrylic resin, a laminate of an acrylic resin and polycarbonate (PC), thin glass, polyimide (PI), polyethylene naphthalate (PEN), polyethylene terephthalate (PET), and urethane thermoplastic elastomer (TPU).

According to various embodiments, the hard coating layer has a thickness between 3 μm and 20 μm.

According to various embodiments, the AF coating layer has a coefficient of friction of 0.2 or less.

According to various embodiments, an protective film is attached to an electronic device, and the protective film includes a base layer disposed on a cover panel, a hard coating layer coated on the base layer, and an anti-fingerprint (AF) coating layer coated on the hard coating layer, such that the AF coating layer has a thickness between 80 nm and 200 nm.

According to various embodiments, the AF coating layer forms a water contact angle of 110 degrees or more with moisture adsorbed onto the AF coating layer from the outside.

According to various embodiments, the AF coating layer is formed by curing a material with a viscosity of 4 centipoise (CPS) or more.

According to various embodiments, the protective film further includes a primer between the hard coating layer and the AF coating layer.

According to various embodiments, the AF coating layer includes polymers that contain the same functional group as the primer.

According to various embodiments, the polymers contain a perfluoro chain. The polymers contain a perfluoro chain and a low-refractivity fluorine chain. The AF coating layer further includes an adhesion promoter bonded between the polymers.

According to various embodiments, an electronic device includes a side member configured to surround a space between a first surface of the electronic device and a second surface facing away from the first surface, a display panel configured to output contents toward the first surface and disposed between the first surface and the second surface, a back cover attached to the second surface, and a protective film attached to the back cover, such that the protective film includes a base layer disposed on the back cover, a hard coating layer coated on the base layer, and an anti-fingerprint (AF) coating layer coated on the hard coating layer, and such that the AF coating layer has a thickness between 80 nm and 200 nm.

According to various embodiments, an electronic device may include a side member that surrounds a space between a first surface of the electronic device and a second surface facing away from the first surface, a display panel that outputs contents toward the first surface and is disposed between the first surface and the second surface, a cover panel mounted on the display panel to protect the display panel, and a protective film mounted on the cover panel. The protective film may include a base layer disposed on the cover panel, a hard coating layer coated on the base layer, and an anti-fingerprint (AF) coating layer coated on the hard coating layer, and the AF coating layer may have a thickness between 1/100 and 1/15 of the thickness of the hard coating layer.

According to various embodiments, an electronic device may include a side member that surrounds a space between a first surface of the electronic device and a second surface facing away from the first surface, a display panel that outputs contents toward the first surface and is disposed between the first surface and the second surface, a cover panel mounted on the display panel to protect the display panel, and a protective film mounted on the cover panel. The protective film may include a base layer disposed on the cover panel, a hard coating layer coated on the base layer, and an anti-fingerprint (AF) coating layer coated on the hard coating layer, and the AF coating layer may be formed by curing an AF coating solution with a viscosity of 4 centipoise (CPS) or more through a micro gravure process.

While the present disclosure has been shown and described with reference to various embodiments thereof, it will be understood by those skilled in the art that various changes in form and details may be made therein without departing from the present disclosure as defined by the appended claims and their equivalents.

What is claimed is:

1. An electronic device, comprising:
a side member at least partially enclosing a hollow formed between a first surface and a second surface of the electronic device, the second surface disposed facing away from the first surface;
a display panel disposed between the first and second surfaces, arranged to display content towards the first surface;
a cover panel disposed on the display panel; and
a protective film mounted on the cover panel, including:
a base layer disposed on the cover panel,
a hard coating layer coated on the base layer, and
an anti-fingerprint (AF) coating layer coated on the hard coating layer, wherein the AF coating layer has a thickness between 80 nm and 200 nm.

2. The electronic device of claim 1, wherein the AF coating layer is disposed at an angle of 110 degrees or more relative to a liquid adsorbed onto the AF coating layer.

3. The electronic device of claim 1, wherein the AF coating layer comprises a cured material having a viscosity of 4 centipoise (CPS) or more.

4. The electronic device of claim 1, wherein the protective film further includes a primer disposed between the hard coating layer and the AF coating layer.

5. The electronic device of claim 4, wherein the AF coating layer includes polymers comprising the same functional group as the primer.

6. The electronic device of claim 5, wherein the polymers comprise a perfluoro chain.

7. The electronic device of claim 5, wherein the polymers comprise a perfluoro chain and a low-refractivity fluorine chain.

8. The electronic device of claim 5, wherein the AF coating layer further includes an adhesion promoter bonded between the polymers.

9. The electronic device of claim 1, wherein the base layer comprises a film including at least one of polyethylene terephthalate (PET), polypropylene, case polypropylene (CPP), polyurethane, polyolefine, and polyimide.

10. The electronic device of claim 1, wherein the base layer comprises a sheet including at least one of polycarbonate (PC), polymethylmethacrylate (PMMA), and a laminate of PC and PMMA.

11. The electronic device of claim 1, wherein the display panel comprises at least one of a liquid crystal display (LCD), a light-emitting diode (LED) display, an organic light-emitting diode (OLED), and a polymer compound.

12. The electronic device of claim 1, wherein the cover panel comprises at least one of glass, an acrylic resin, a laminate of an acrylic resin and polycarbonate (PC), thin glass, polyimide (PI), polyethylene naphthalate (PEN), polyethylene terephthalate (PET), and urethane thermoplastic elastomer (TPU).

13. The electronic device of claim 1, wherein the hard coating layer has a thickness between 3 μm and 20 μm.

14. The electronic device of claim 1, wherein the AF coating layer has a coefficient of friction of 0.2 or less.

15. A protective film attached to an electronic device, the protective film comprising:
a base layer disposed on a cover panel of the electronic device;
a hard coating layer coated on the base layer; and
an anti-fingerprint (AF) coating layer coated on the hard coating layer,
wherein the AF coating layer has a thickness between 80 nm and 200 nm.

16. The protective film of claim 15, wherein the AF coating layer is disposed at an angle of 110 degrees or more relative to moisture adsorbed onto the AF coating layer.

17. The protective film of claim 15, wherein the AF coating layer comprises a cured material having a viscosity of 4 centipoise (CPS) or more.

18. The protective film of claim 15, further comprising:
a primer disposed between the hard coating layer and the AF coating layer.

19. The protective film of claim 18, wherein the AF coating layer includes polymers comprising the same functional group as the primer.

20. An electronic device, comprising:
a side member at least partially enclosing a hollow formed between a first surface and a second surface of the electronic device, the second surface disposed facing away from the first surface;
a display panel and disposed between the first and second surfaces, arranged to display content towards the first surface;
a back cover attached to the second surface; and
a protective film disposed on the back cover, including:
a base layer disposed on the back cover,
a hard coating layer coated on the base layer, and
an anti-fingerprint (AF) coating layer coated on the hard coating layer,
wherein the AF coating layer has a thickness between 80 nm and 200 nm.
